(19) United States
(12) Patent Application Publication
(10) Pub. No.: US 2007/0164525 A1
(43) Pub. Date: Jul. 19, 2007

(54) Apparatus and Methods for Transporting, Storing and Airing Equipment

(76) Inventor: Michael Rodrigues, Quincy, MA (US)

Correspondence Address: NIELSON LAW OFFICE, 1212 HANCOCK STREET, SUITE 120, QUINCY, MA, 02169, US

(21) Appl. No.: 11/624,127

(22) Filed: Jan. 17, 2007

Related U.S. Application Data
(60) Provisional application No. 60/766,393, filed on Jan. 17, 2006.

(51) Int. Cl. B62B 1/00

(52) U.S. Cl. 280/47.18

(57) ABSTRACT

An apparatus for transporting, storing and airing equipment is provided having a container and a support structure. The container is defined by a plurality sides of least one of which is movable to provide access to all of or a portion of an interior of the container. Equipment can be releasably attached to the interior via an organized array of attachments disposed along an interior surface of one or more side. The support structure can elevate a side of the container thereby disposing the container at an angle relative to a support floor. In that position, the container can be maintained in an open configuration allowing an air flow to pass over and/or through the equipment for airing.

### CROSS REFERENCE TO RELATED APPLICATIONS

This application claims priority to U.S. Provisional Application No. 60/766,393 filed Jan. 17, 2006, which is incorporated herein by reference in its entirety.

### BACKGROUND OF THE INVENTION

This invention relates generally to transportation, storage and airing of equipment, for example, equipment prone to repeated dampness or other conditions after use.

Sporting equipment such as hockey, baseball, lacrosse and football, for example, each utilize a specific set of equipment and clothing, although of differing shapes. Such equipment can become damp or even wet due during normal (or extreme) use, and because of external environments, such as rain and ice. Equipment can also become damp and/or wet from wearer perspiring during participation in the sport. Indeed, such equipment is perhaps legendary for becoming wet from sweat, and foul smelling too. In any event, moisture can and often does degrade the equipment: ice skating blades rust and dull, baseball bats warp and delaminate, football helmet-guards compress, and leather rips and cracks.

Further, a player generally transports equipment from home or other locations to various venues such as arenas, ice rinks and the like. Once there, “short-haul” trips between the playing field or rink and the locker room can occur where a portion of the equipment is transported therebetween and accessed for use. For example, a player might first gather at home and transport to a locker room necessary equipment to play a sport. There, a portion of the equipment is unpacked and worn, but the remainder of equipment is transported to a playing field or rink for use. After use, a portion of the equipment is re-packed and re-transported back to the locker room, where the worn portion is again repacked. Then, the equipment and clothing is returned home where it must again be unpacked for airing out. Not only is it time consuming, but it creates clutter.

Airing equipment generally requires significant space to lay out the equipment and clothing, and especially for team sports, a locker room may not have sufficient space for adequate airing of the team's equipment. Indeed, there is generally insufficient area to properly “air out” one or more sets of equipment in a single room. Further, airflow within a room is typically of a fixed amount preventing effective drying of equipment. Thus, this necessitates the unpacking and re-packing of equipment after each use, and the transportation of the equipment between the actual playing area (e.g., ice rink) and the locker room where the equipment is again unpacked, re-transported to a further location and laid-out for proper airing. Home use can be especially troublesome due to limited space and clutter.

Because those problems and others are known, various attempts to mitigate the inconveniences associated with sporting equipment transportation and storage have been made, but to date, they have not proven sufficiently effective in many cases. For example, a sports equipment-drying container is disclosed by La Porte in U.S. Pat. No. 6,263,591, issued Jul. 24, 2001. The container is a box shaped body with a cover. A fan is mounted to a side of the body and a heating pad is disposed within the body. The fan removes heated air from within the enclosed body, and thus, internally stored equipment is dried via heated air. Yet the fan/heater requires a constant source of line-voltage (e.g., household) power preventing ease of airing multiple sets of equipment within a fixed area, and the container can be somewhat heavy for transportation. Heating requires significant power and where multiple containers are used, the power requirements can become expensive. Further, some types of equipment can be adversely affected by heat.

Another attempt to solve some of problems noted above is disclosed by Buhler et al. in U.S. Pat. No. 6,780,101, issued Aug. 24, 2004. It provides for drying and/or scenting sports equipment in a sports bag that has two openings covered by a mesh fabric or plastic screen. One opening is used to receive a blower fan housing engaged onto a mounting at that opening. A second opening allows air to escape. An air freshener can be inserted into a pocket located in the fan housing. But again, that requires a constant line-voltage source, and multiple bags require multiple outlets making it difficult to allow an entire sports-team to dry equipment at a single location.

Still another attempt to provide a solution to some of the above problems employs a separate blowing device coupled to a sports bag via a flexible hose, as disclosed by Dhaemers in U.S. Pat. No. 5,930,915, issued Aug. 3, 1999. The bag has a plurality of internal manifolds, each having a plurality of holes guiding airflow into and through the bag to dry its contents. Air filters can be mounted on the bag to remove odors. Although, the bag can be transported, airing requires the detachable fan, also requiring line voltage. Further, both pieces (i.e., bag and air distributor) must be independently transported, and if the air distributor is transported within the bag, cargo volume is reduced and weight increased. Further, the bag is not easily re-configured to provide transportation and airing for a variety of equipment.

But of note, none of the above solutions provide for efficient packing and unpacking of equipment. As mentioned, often equipment must be packed, unpacked, repacked, transported short distances between the playing field, locker room and/or home, and again unpacked. That can be time consuming, and in certain environments, cause damage to the equipment.

The above problems are in no way limited to sporting equipment. Other equipment such as field electrical testing equipment, everyday clothing articles used while traveling, and other items can become damp, foul smelling and need drying for preservation or pleasantness. Of particular importance is the requirement to prevent damages to delicate equipment, such as portable laboratory equipment, electrical equipment, testing equipment and other types, commonly transported and used in various damp environments yet can degrade from that dampness.

Thus, there is a need to provide transportation, storage and airing of equipment that is easy to use, has low space requirements, and can provide airing of that equipment easily.

### SUMMARY

Apparatus and methods for transporting, storing and airing equipment are provided according to one aspect of the invention. A container has an interior defined by one or more sides, each side having an interior surface. One or more sides can be opened providing access to a portion or the entire interior of the container. Attachments are arranged along the interior surface(s) of one or more of the sides according to the size, shape, weight, and order of use and/or location of use pieces of equipment. The equipment is releasably secured by the attachments. A support structure elevates an end of the container such that the container is disposed at an angle relative to a support floor upon which it rests. In that position, the container can be opened with the equipment therein, allowing an air flow to pass over and through the equipment. The support structure can maintain the container disposed at an angle less then approximately 90 degrees and more than approximately 30 degrees relative to a floor or other support platform.

The support structure can be external or integrated into the container, or any combination thereof. It can have multiple support legs, such as a bi-pole structure, having a pivot point along a portion of the container to be elevated, and a retaining cord extending between one or more of the bi-poles and a portion of the container disposed beneath the pivot. Alternatively, or in conjunction therewith, the support structure can be integrated with the container and include rods and/or plates disposed in or externally to sides of the container. A hinge assembly or pivot with stops enables the container to be disposed in the elevated position with a smaller footprint than would be required with an external support structure.

The container can have a fan assembly powered by a variety of power sources including batteries, rechargeable or otherwise, solar cells, A/C house current, or any combination thereof, and can be integrated into the fan assembly, container or support structure, or any combination thereof. Wheels and/or a pull handle, and a lifting handle can be provided to facilitate transportation.

Methods of using an apparatus for transporting, storing and airing equipment are also provided. Equipment can be releasably secured in the interior of the container at a first location and transported to a second location. There, one or more sides can be opened proving access to a portion of equipment therein, and that equipment can be removed. The opened side(s) can then be closed and the container and remaining equipment therein can be transported to a further location, and there, the same or differing sides can be opened to provide access to the same or differing portions of the container, and the equipment therein can be removed. Thereafter, particularly after using the equipment or a portion thereof, one or more sides can be opened and a portion of the equipment releasably secured in the interior of the container. The opened sides can be closed and the container transported to the second (or a further) location where one or more sides are opened an a further portion of the equipment (or the remaining equipment) can be releasably secured therein. Then, the opened sides can be closed and the container and again be transported. There can be numerous locations, and numerous portions of equipment removed or returned to the container at each or all of those location.

### BRIEF DESCRIPTION OF THE INVENTION

Those and other features of the invention will become more apparent from the detailed description below, in which reference is made to the following drawings, wherein:

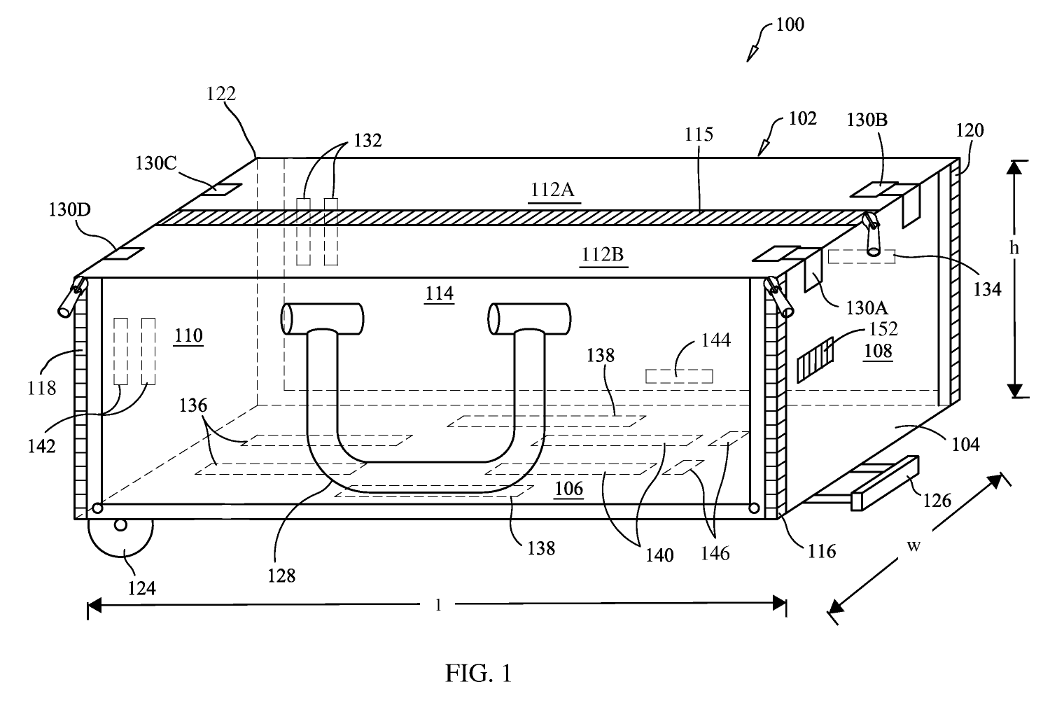

FIG. 1 is an embodiment of a transportation, storage and airing container and support structure according to the invention that has a rigid body;

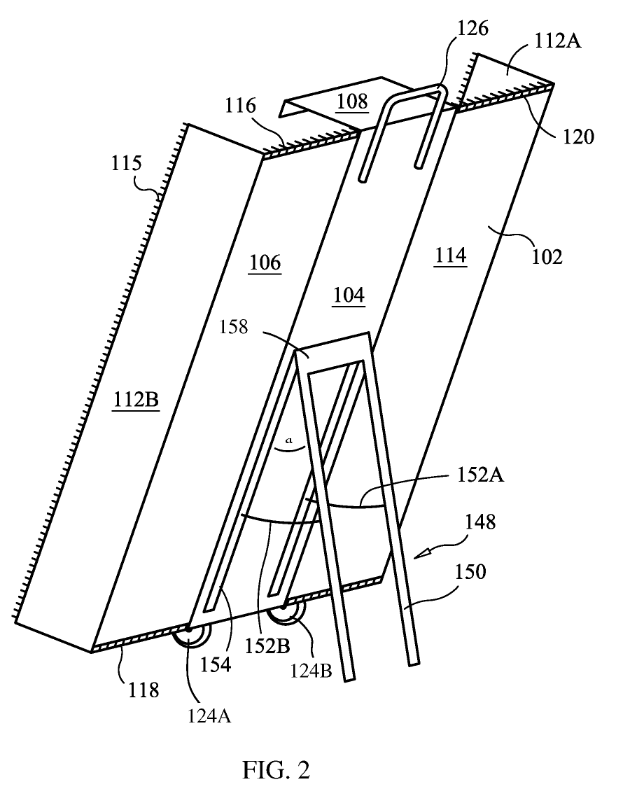

FIG. 2 is the container of FIG. 1 with the support structure deployed elevating the container at an angle relative to a support floor with the container in an opened configuration for airing of equipment;

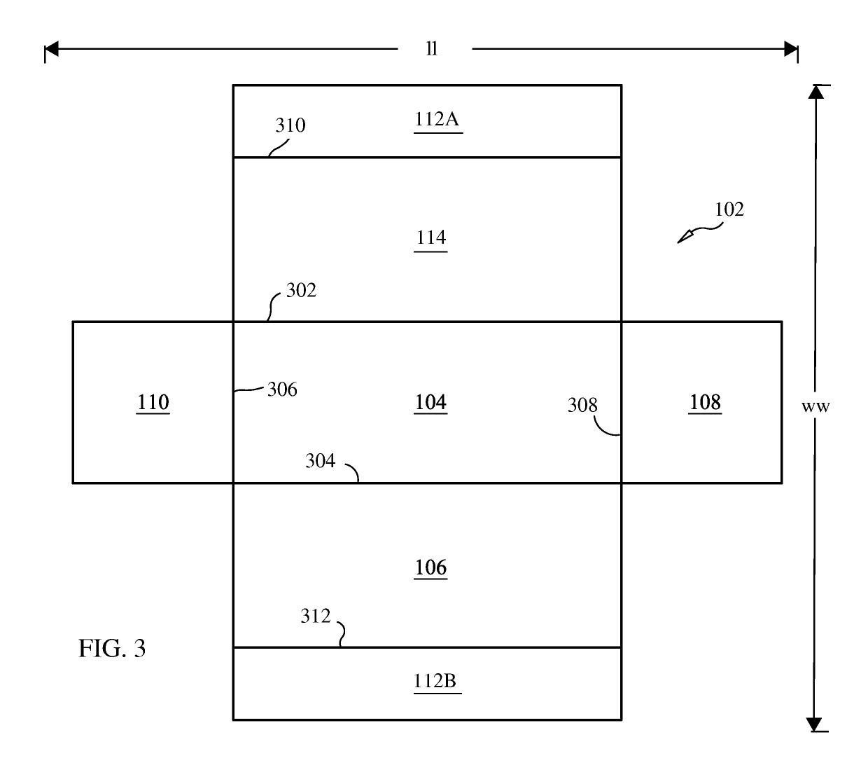

FIG. 3 is the container of FIG. 1 showing a single-piece manufacture having sides in a flat configuration;

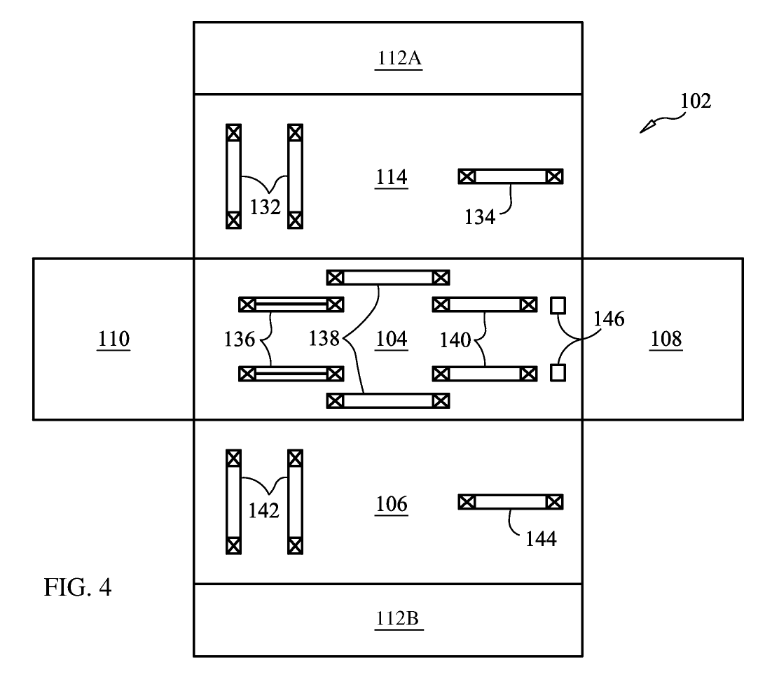

FIG. 4 is the single-piece manufacture of FIG. 3 having attachments arranged along surfaces of sides of the container;

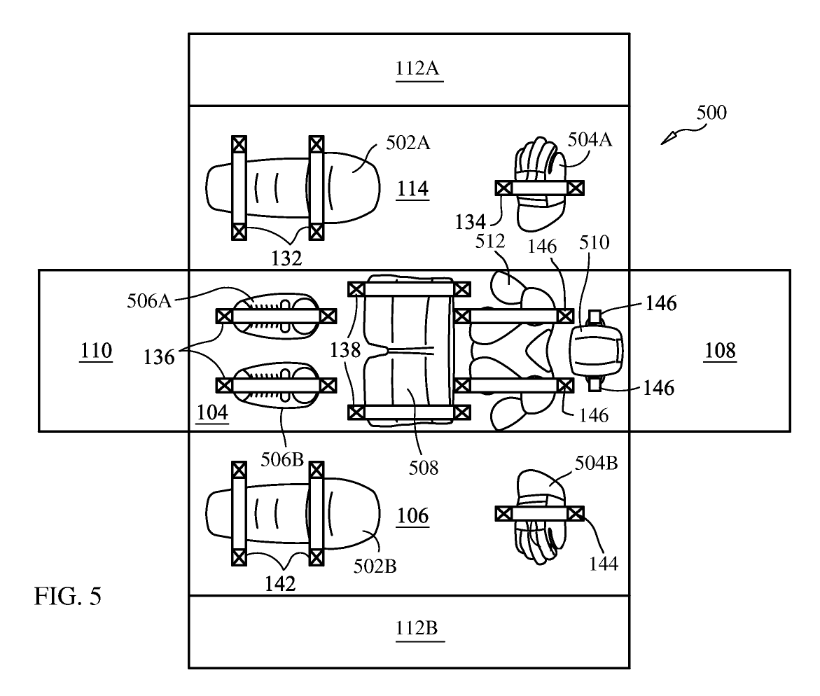

FIG. 5 is the single piece manufacture of FIG. 3 with attachments of FIG. 4 populated with equipment; and

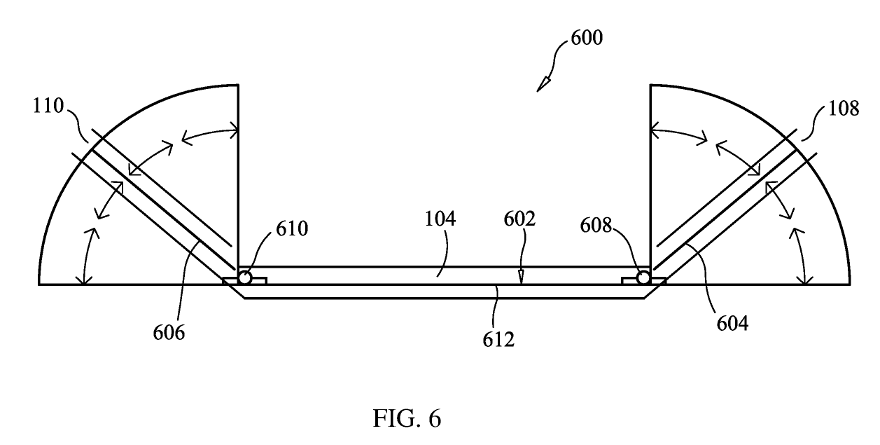

FIG. 6 shows an embodiment of a hinge assembly suitable for maintaining a container in an open configuration.

### DETAILED DESCRIPTION

The present invention provides transportation, storage and airing apparatus and methods of use thereof. The apparatus has a container and a support structure. The container is adapted for use with a set of equipment or other cargo that may be subjected to wet and/or moist environments. The container has an exterior and interior, the interior defined by interior surfaces of one or more sides. Attachments that can releasably secure equipment are disposed along interior surfaces of one or more of the sides and arranged according to a variety of considerations, e.g., shape, size, weight and utilization requirements of the equipment. Sides of the container can be opened providing access to selected portions or all portions of the interior of the container, and thus, access to all or to a portion of the equipment therein. The support structure elevates a side of the container with respect to a support floor, and thereby, disposes the container at an angle relative to the support floor. In that position, the container can be opened to allow air to pass over and/or through the equipment. A fan assembly can be incorporated into the container and powered using a variety of means to facility air flow.

Those skilled in the art will appreciate that the containers and support structures disclosed herein are useful for transportation, storage and airing of sporting equipment, e.g., ice hockey uniforms and equipment although that is but one non-limiting example. Another example, for instance, can be used to transport, store and air electrical equipment used in the field (e.g., outdoors or high humidity environments) where it can be exposed to rain and/or dampness. Thus, it is envisioned that the containers and support structures are useful in a variety of ways and with a variety of equipment, and indeed, non-equipment items as well.

FIG. 1 illustrates one embodiment 100 of the invention for transporting, storing and airing equipment having a container 102 and a support structure 148 (FIG. 2). Container 102 is defined by a plurality of sides 104-114 creating interior and an exterior areas of container 102. Sides 104-114 are configured with releasable side fasteners 115-122, 130 that can releasably join adjacent sides providing full or partial closure of and/or access to container 102. Support structure 148 can be deployed to elevate container side 108 a distance from a support floor on which container 102 is resting, thus disposing container 102 at an angle relative to the support floor, as will be described below. Attachments 132-146 are disposed on interior surfaces of one or more sides, here sides 104, 106, 114, however, attachments can be disposed on interior surfaces of more, less or other sides, and indeed, in one embodiment attachments are disposed on exterior surfaces of one or more sides. In the illustrated embodiment, each attachment is disposed using an organization or arrangement according to a shape, size and intended use of pieces of the equipment, e.g., a hockey glove, shoulder protective pad and shorts/pants, as will be described below.

Container 102 is illustrated as an elongated structure defined by six rigid sides 104-114. In one embodiment, sides can be non-rigid, e.g., composed of a durable fabric such as Gortex™ or nylon, although other materials can be used that are preferably durable and breathable. Preferably, where non-rigid sides are used, at least one side, e.g., bottom side 104, should be of rigid construction or have a hard casing or structure to provide support for container 102 when disposed in an airing mode, as will be described below. In another embodiment, there can be more or less sides, or the sides can have curvatures, bends and/or angles. For example, a container can be round, triangular, oval or any combination thereof. A single side can have multiple bends and/or designs for both aesthetics and/or to aid in releasably securing equipment within that container, or even to facilitate the size, shape and/or weight of equipment such as to provide a resting platform, compartment or the like. Sides can be colored, printed or embroidered, signifying the type of equipment therein, an owner's or owners' name, and/or a team insignia, just to name a few. Of course, care should be taken that the coloring, printing and/or embroidering does not significantly degrade the sides, or in the case where the sides are breathable, does not significantly affect the breathability of the container. Further, sides should be constructed of materials that are substantially mold and mildew resistant, and/or have properties that resist odors.

One or more sides 104-114 can have padding or a protective covering along its interior and/or exterior surface providing protection for equipment disposed within the container 102. For example, bottom side 104 can have a padded layer manufactured of a variety of materials such as foam, foam core materials, air pillows, fluid filled pillows, or other type of padding as will be known to those skilled in the art. Preferably, padding is selected that will be durable and will not degrade with moisture; it may include a cover or multiple-layer construction to provide a hydrophobic surface, for example. In one embodiment, a padded layer is removable for cleaning.

Container 102 illustrated is sized to accommodate ice hockey equipment for use by an average adult hockey player, and has a length l of approximately 40 inches, a height h of approximately 16 inches, and a width w of approximately 15 inches. If the player, however, is a youth, the dimensions can be decreased preserving construction materials and reducing the amount of space (e.g., floor space or footprint) occupied by the container. And also allowing a youth to easily transport the container. For example, a container for a youth hockey player can have a length l of approximately 30 inches, a height h of approximately 12 inches, and a width w of approximately 13 inches. Conversely, if a player is large, the dimensions can be increased at the cost of construction materials and occupied space and size, for example, 50 l by 20 h by 17 w, for example. The container 102 can be sized to accommodate other sporting equipment. For example, a container for baseball equipment may have an increased length l, of approximately 50 inches to accommodate a regulation-sized bat and equipment, and the container may have a decreased height h of about 10 inches. In one embodiment contemplating the use of electrical test equipment, the container can be sized slightly larger than the dimensions of the equipment therein. In any case, the dimensions of the sides, and hence of the container, are preferably determined depending on the size, shape and weight of the equipment to be placed therein, intended use of that equipment, and ease of transporting the container.

Fasteners 115-122, 130 can be disposed between adjacent sides 104-112 or can be used to allow a single side to open in a split fashion, e.g., top side 112A 112B. Fasteners 115-122, 130 can provide closure of container 102 and be released to provide access to its interior. Preferably, fasteners 115-122, 130 provide repeatable releasable joining of the sides thus aiding in closure of container and access to its interior. Thus, fasteners 115-122 can be constructed of any combination of zippers of either metal or plastic construction including nylon construction, and Velcro™ or other hook/loop assemblies, clips, snaps, ties or other means for repeatably joining two sides. As illustrated fastener 115 releasably joins two portions of top side 112, i.e., 112A and 112B. Fasteners 116, 118, 120 and 122 are also illustrated as zippers and releasably join adjacent sides front side 106 and right side 108, front side 106 and left side 110, right side 108 and back side 114, and left side 110 and back side 114, respectively.

Fasteners 115-122, 130 can be of a variety of types in a single embodiment based on the sides to be joined by those fasteners. For example, in the illustrated embodiment, fasteners 130 A-D are illustrated as having snaps to accommodate efficient opening of top side 112. In another embodiment, however, top side 112 can be sized to extend over right side 108 and left side 110, the extending portions having fasteners running along and adjacent to an upper surface of right side and left side 108 110, respectively. Extending portions of top side 112 can be rabbited, grooved or otherwise manufactured to mate with a groove or other mating means of the right and left sides. As such, a fastener can be manufactured of Velcro or other material that can be applied along the sides or edges. Preferably, such fastener provide a complete releasable sealing between top side and the left and right sides preventing any equipment that may become loose or otherwise disposed within container to fall out.

Fasteners 115-122, 130 can, but need not, be disposed between all adjacent sides, and indeed, preferably not all adjacent sides have fasteners. For example, as illustrated there is no releasable fastener between front side 106 and bottom side 104, and thus, front side 106 and bottom side 104 are permanently joined, although the sides may be manufactured such that front side 106 can rotate relative to side 104 to form a singularly flat platform (FIG. 2), or be held at an angle therebetween (FIG. 6).

Attachments 132-146 are disposed along an interior surface of one or more of the sides 104-114 and provide releasable attachment of equipment. Attachments 132-146 can be removably attached to the interior surface(s) to provide flexibility of placement of the equipment through use of snaps, Velcro, or other means. Alternatively, or intermixed therewith, attachments 132-146 can be permanently secured to a side, as when weight or size of equipment makes removable attachments unreliable or costly to manufacture. Preferably, attachments 132-146 are disposed to releasably secure one or more pieces of equipment during transport, storage and/or airing. Further, attachments 132-146 are preferably arranged to organize equipment according its sequence of use in relation to other equipment, its frequency of use and/or other considerations. Thus, attachments 132-146 can be arranged or configured to provide access to one or more pieces of equipment during partial access into the container, e.g., from a right side 108 access or left side 110 access. Such arrangements facilitate access to equipment or portions of equipment according to its intended use and/or the location of its intended use.

It will be appreciated by those skilled in the art that attachments 132-146 can be of a variety materials selected according to the equipment to be secured. For example, attachments can be Velcro straps, hooks, button or buckle straps and the like. In one embodiment, attachments are slots disposed in a side, such as for securing a blade of an ice skate. In any event, attachments 132-146 should be constructed using materials and means suitable for the size and weight of the equipment to thereby releasably secure, and should be selected of materials resistant to moisture, odors and corrosion.

Pull-handle 126 provides a means for easily transporting container 102 in conjunction with wheels 124 (See also, FIG. 2). Pull-handle can be retractable for storage and while in transportation, and can be extended in a direction away from container 102 to allow easy grasping of the handle when desired. That can be accomplished using a variety of means including tubular construction, solid construction handle assemblies, and the other configurations. In one embodiment, a pull-handle can be incorporated into a support structure. Preferably, pull-handle is coupled to a side of container, and more preferably, to a rigid side of that container to assist in pulling it along, e.g., bottom side 104. Wheels 124 are preferably made of light-weight yet durable material, such as a hard plastic, hard composites or rubber that can withstand repeated rolling along a variety of surfaces, e.g., concrete, walk-ways and the like.

Fan assembly 152 is illustrated as disposed along right side 108, and will thus, blow air from a top position toward a bottom position when container 102 is disposed in the elevated position described above. Fan assembly 152 can be powered by a portable power source that can be disposed in the interior of container 102, however, in one embodiment the power supply can be solar cells disposed on exterior surfaces of the sides, and such would be appropriate where airing of the equipment takes place outdoors or in well lighted areas where solar cells can provide sufficient power to activate a fan. In another embodiment household current can be used, and it is envisioned that a fan assembly can use a wide variety or had dual or multiple power supplies, e.g., AC/DC type configurations. Further, fan assembly 152 can be disposed in virtually any location or side, as long as it can provide an air flow over and/or through equipment secured within the interior of the container 102. Of course, it will be appreciated by those skilled in the art that not every container will have a fan assembly, and indeed, equipment can air using non-enhanced air flow currents, e.g., those commonly in a room.

FIG. 2 shows container 102 in an elevated position having the support structure 148 deployed. Support structure 148 has a bi-pole or modified bi-pole configuration having two elongated structures 150A 150B. Elongated structures 150 are illustrated as having a common proximal end 158 or otherwise joined, and coupled to or attached to bottom side 104 of container 102, however, it can be attached to virtually any side such that the container can be opened when disposed in the elevated position. Proximal ends 158 can be coupled to a side using a variety of means, and as illustrated, a hinge assembly is used allowing the elongated structures 150 to be rotated in a direction away from bottom side 104 creating an angle a therebetween. To prevent the elongated structure 150 from rotating too far, stops such as strings 152 can be used to constrict movement of the elongated structures 150; however, in one embodiment a pivot assembly with pre-selected stops can be used to accomplish the same. Distal ends of the bi-pole structure can have rubber caps or other means for both protecting the distal ends while resting on the support floor, and to provide a more stable disposition of the container 102, e.g., a high-friction covering. Illustrated, bottom side 104 is adapted to secure the elongated structures 150 when not deployed, here by using Velcro strips 154 that can releasably secure the elongated structures 150. In one embodiment, snaps can be used for the same purpose, or in still another embodiment, rabbits or groves can be manufactured a bottom side of that container that can receive the elongated structures and releasably secure them. Left side 110 (not shown) can be adapted to rest at an angle on the support floor in one embodiment, through use of a hardened edge, hard cap, rubber stripping or by other means.

It will be appreciated by those skilled in the art that support structure 148 elevates an end of container 102 relative to a support floor, positioning that container at an angle to the support floor. Thus, when the container is in an open configuration as illustrated, air can flow over and into equipment secured within the container causing the equipment to dry, de-odorize and the like. It will also be appreciated that a wide variety of means can be used to elevate a container including mono-pole, tri-pole and even solid structures that can be embedded in a side, e.g., side 110, and can be retracted to provide a support structure having a base that will disposed the container in an up-right position.

Container 102 is illustrated in an open position allowing air to pass over and/or through equipment releasably stored therein (FIG. 5). Container 102 can be opened in a variety of ways and configurations, but preferably, container is sufficiently opened to allow air to freely pass over and/or through the equipment. Illustrated, container 102 is opened by releasing fasteners 115-122, 130 such that sides 104, 106 and 114 form a substantially flat platform. Sides 112A and 112B are illustrated at a generally perpendicular angle to sides 114 and 106, respectively, and that can be accomplished using a structure such as the one illustrated in FIG. 6 and as will be described therewith. In one embodiment, sides 112A and 112B can be generally parallel to the other sides forming a large, substantially flat platform, or indeed, can be at almost any angle relative to sides 104, 106 and 114 as long as there is no significant interference with the support structure 148, nor any interference with air flow. Further, side 108 is also illustrated as generally perpendicular to side 104, and such is advantageous for directing an air flow from a fan assembly, e.g., 156, when such assembly is a feature of that embodiment.

FIG. 3 shows containers 102 in a flat configuration illustrating a one-piece construction. Sides 104-114 can be manufactured from a single piece of rigid material, although as noted above, sides can be designed and/or manufactured in multiple pieces and/or utilize such manufacturing techniques as injection molding or stamping; they can be manufactured from durable fabric (e.g., nylon), or otherwise. As illustrated, however, container 102 is manufactured as a substantially flat material that can preferably be angled or bent along edges 302-312 disposed between adjacent sides as shown, to at least a 90-degree angle without significant degradation in material strength. Edges 302-312 can be scored or rabbited, however, other means of bending or rotating one or more sides to manufacture container 102 can be used. Those skilled in the art will appreciate that container 102 can be manufactured in a variety of ways using a variety of techniques. For example, where sides are non-planar or sculpted, stamping or pre-injection molding can be used depending on the material selected for constructions, e.g., metal or plastics, respectively. In one embodiment, sides 104-114 can be manufactured using multiple pieces of material, and indeed, can be of varying materials. Preferably, bottom side 104 is sufficient rigid to support the container 102 when disposed in the elevated position using support structure 148 (FIG. 2). That can be accomplished using other means as well, such as reinforcements, re-barb type structures, and the like.

Container 102 is illustrated as a single piece having dimensions that result in providing a container of the dimensions illustrated in FIG. 1. In other embodiments dimensions of the material can be altered, modified or changed depending on the desired dimensions of the resulting container. Indeed, they need not be square/rectangular but can have curves, bends or other shapes including three-dimensional variations such as a thicker bottom side 104 than a thickness of a top side 102.

As illustrated, the single piece of material has a length ll of approximately 72 inches and a width ww of approximately 62 inches resulting in the dimensions l and w as shown in FIG. 1 when assembled. Illustrated, bottom side 104 is substantially rectangular in shape and is adjacent to four other sides: front side 106, right side 108, back side 114 and left side 110. Top side 112 is illustrated as bifurcated having two portions 112A 102B as noted above (FIG. 1), and as such, front side 106 is adjacent to one portion of top side 102B, and back side 114 is adjacent to a further portion of top side 112A.

Edges 302-312 are disposed between adjacent sides and provide an edge therebetween. It will be appreciated by those skilled in the art that as used herein, an edge can be a scored or partial cut into the material to allow bending, a chamfered cut; an edge can be of a same or differing material, or otherwise. In one embodiment a container is constructed of multiple-piece materials, such where sides are manufactured separately, and edges can provide joining of the sides. In that embodiment, edges can be constructed of glue or adhesives for permanent bonding, hinged, screwed or otherwise, indeed, some edges can be manufactured from a breathable mesh material. Preferably, sides that provide full or partial access have edges that provide repeated opening and closing of the container 102. That can be accomplished by selection of edges to provide a “hinged” edge, or hinge assemblies, pivot points and other configurations and any combination of the above is envisioned. For example, while edges 302-308 might be of solid construction or perhaps hinge assemblies (as illustrated in FIG. 6), edges 310-312 can be a mesh screen material to allow ventilation even when the container 102 is closed and in transportation.

In any event, right side 108 and left side 110 can be folded, bent or otherwise elevated to form a substantially perpendicular plane with respect to bottom side 104, as can front side 106 and back side 114. Fasteners 115-122, 130 (FIG. 1) can be applied to adjacent sides, e.g., between right side 108 and back side 114, before or after folding, and can be used to secure those adjacent sides. As noted above, differing types of fasteners can be utilized. The first portion of top side 112B can be similarly disposed thereafter, before, or in any combination, at a substantially perpendicular plane to front side 106 and the second portion of top side 112A can be disposed at a substantially perpendicular plane to back side 114. Bending can take place in any order depending on the type of material and machinery used to contract the container 102.

Other features such as wheels 124, support structure 148 and/or lifting handle 128 can be incorporated into the manufacturing process or subsequently fitted as options. Such techniques will be appreciated by those skilled in the art.

FIG. 4, in conjunction with FIG. 5, shows one arrangement of attachments 132-146 configured and attached to interior surfaces of sides 104, 106, 114 of container 102. Attachments 132-146 provide releasable attachment of, in this case, hockey equipment, although it will be appreciated by those skilled in the art that other types, sizes and configurations of attachments are applicable to other types, sizes and configurations of equipment. Illustrated, however, attachments 132-146 are organized and/or arranged to provide releasable securing of hockey equipment in the container interior in such way as to allow full and partial access to the equipment as will be described below and as shown in FIG. 5. Attachments can be of an elastic strap variety as illustrated, and attached to the interior surface of a side using Velcro, gluing, stitching or other means. The interior surfaces are correspondingly adapted to receive the attachments. In one embodiment, grooves can be cut into a side, or alternatively, a block with a groove attachment 136 can be attached to a side, that can receive a blade of a skate, with an elastic type strap (if desired) to further secure the skates. Those skilled in the art will appreciate that a wide variety of means are available for releasably securing equipment to a surface of a side, and preferably, the means chosen can secure equipment safely during transport, storage and airing of the equipment. In one embodiment, attachments are disposed among differing sides, e.g., right and/or left sides 108 110, and/or top side portions 112A 112 B.

FIG. 5 shows equipment releasably secured by the attachments illustrated in FIG. 4. For example, hockey leg protectors 502A 502B are illustrated releasably secured by attachments 132 142, respectively. Attachments 132 142 are illustrated as substantially elastic straps, however, they can be non-elastic straps with Velcro™ (or other hook/loop material) ends mating with mounting pads disposed and joined to sides 112 106, respectively. Similarly, gloves 504A 504B are illustrated as secured via attachments 134 144, respectively. In one embodiment attachments are permanently disposed as illustrated, and in another embodiment they can be removed and re-attached to sides to provide variably equipment to be secured in differing arrangements and/or configurations.

Skates 506 can be secured to bottom side 104 via attachments 136. Here, attachments 136 are grooves or slots either manufactured into bottom side 104 or disposed on bottom side 104 via cut blocks, assemblies or otherwise. Attachments 136 receive and releasably secure a portion of a blade running along a bottom of each skate, and here, also have an elastic strap to further aid in securing the stakes. Alternatively, one or more hooks or straps as described above can be used to attach skates to side. As will be appreciated by those with skill in the art, a variety of attachments can be used to secure equipment that are similar or different than those used for other equipment, e.g., leg protectors and gloves.

Shorts/Pants 508 are illustrated as secured via attachment 138 in a flat position that advantageously aids in airing. In embodiments where space is limited, additional equipment can be disposed over or under shorts/pants, and indeed, in one embodiment shorts/pants can be folded to preserve space as long as sufficient airflow can be provided to air them.

Helmet 510 is illustrated as secured via attachment 146. Similar to gloves 504, helmet 510 is disposed near right side 108 to provide quick access via that side 108. As can be appreciated from FIGS. 4 and 5, a hockey player can transport container 102 from home to a locker room. There, the player can open, for example, top side 112 and remove and dress in the clothing, e.g., shirt, pants. Then, container 102 can be re-closed and transported to an ice rink, where the right side 108 can be quickly opened and the player can remove the gloves 504 and helmet 510. Further, the player can quickly open the left side 110 and easily remove the skates 136. Thus, a “one-touch” technique for removing equipment at its intended destination is accomplished, and re-arrangement and/or “rummaging” through the equipment to find certain items is eliminated or greatly mitigated. Those skilled in the art will appreciate that organizations can be developed for other sports and/or other types of equipment, and that quick access is only one consideration among several that can include size, weight and place of use of the equipment.

FIG. 6 shows an embodiment according to the invention of a locking hinge support assembly 600 that can be embedded or otherwise coupled to container 102 and allows sustained opening of the container 102 while an airing mode, for example. Hinge support assembly 600 has a bottom side support 602, a right side support 604 and a left side support 606. Bottom side support 602 is coupled at opposing ends to the right and left side support 604 606, respectively, via hinges 608 610, also respectively. Hinges 608 610 can have stop points, e.g., at 0 (i.e. where right and/or left side supports 604 606 are substantially parallel to center support 602), 30, 45, 70, 80 and/or 90 degrees (i.e., where right and/or left side support 604 606 are substantially perpendicular to center support 602) with respect to bottom side rod 602. Hinge support assembly 600 can be embedded within container sides 104 108 110, and in one embodiment it is coupled to exterior surfaces of those sides, or alternatively, along interior surfaces of those sides.

In one embodiment, hinge supports are substantially flat plates that are embedded in or attached to container sides 104 108 110. As such, the plates can provide rigidity across a portion of the sides 104 108 110. Advantageously, such supports can provide the same function as support structure (FIG. 2) via providing sufficient support to dispose container 102 on a side, e.g., left side 110, in an upright position during airing mode. In such case, a stop can be manufactured in hinge assembly 600 to dispose the container resting on left side 110 with bottom side 104 at an angle relative to the support floor greater that approximately 45 degrees and less than approximately 90 degrees. The stop should be placed such that container 102 will not tip over (e.g., consideration for the container's center of gravity with equipment disposed therein), and the container opened for airflow. In one embodiment, supports 602-606 are substantially elongated and rigid rods. Those skilled in the art will appreciate that other means can be used to provide the functions of the hinge assembly described here, and those means are envisioned.

In use, a container 102 as described herein can have multiple modes or configurations, e.g., transportation, storage, access, and airing modes. There can, however, be more or less modes and modes can be combined, separated or otherwise modified. In a transportation mode, the container 12 can be fully closed with the equipment releasably attached within the container interior using attachments 132-146 arranged on an interior surface of one or more sides 104-112 of the container 102. Preferably, attachments 132-146 are arranged to releasably secure the equipment, and to accommodate access thereto. Transportation as used herein can include not only long-distances such as from a home to a sports arena, or transport via common carrier, but can also include short-distance transportation, e.g., from a locker room to an ice rink.

In a storage mode, the container 102 can be fully or partially closed, but generally, the container is disposed according to where it can be placed, e.g., on its lower side, end, or otherwise, depending on the size and shape of the storage space. The container 102 is sized, among other considerations, to accommodate equipment intended to be stored therein, and also to minimize storage space requirements, such as in a standard closet or under a bed, or other such common location, e.g., home, office, locker room or other area.

An access mode can be described as providing for full access and/or partial access configurations, also referred to herein as modes. In a full access mode, a relatively large opening can provide full access to all or substantially all equipment within the container. For example, a large top side 112 can be opened, or indeed, all sides 104-112 can be opened providing a substantially flat surface upon which all equipment is releasably secured, or alternatively, where hinge assemblies are used, such as the hinge assembly 600, the container 102 is not in a flat configuration, but nonetheless, all equipment is easily accessible. That mode can be used for packing or unpacking all equipment within the container, or used when a majority of equipment is being removed or replaced within the container. A partial access mode provides access to only a portion of the equipment and can be used for quickly accessing a selected portion or portions of the equipment, for example. Partial access can be useful for accessing only a pair of ice skates at ring side, for example, or a pair of hockey gloves. Of course, the partial access mode can be contemplated in various configurations depending upon the equipment and application of the equipment at various locations.

An airing mode can be used airing equipment secured within the container 102. The airing mode involves disposing the container on an end or upright angle via deploying a support structure, e.g., support structure 148, and fully or partially opening the container 102 to allow or provide airflow across and/or around the equipment (FIG. 2). The container can be disposed in such way to reduce the footprint of the container on a supporting floor or surface allowing multiple containers to be placed in proximity within a limited area, e.g., a locker room. Preferably, container 102 is disposed less than approximately 90 degrees and greater than approximately 30 degrees relative to the floor or other support platform to allow airflow from lower portions of the equipment to rise without “re-venting” across higher portions of the container. As will be appreciated by those skilled in the art, a container can be totally opened, e.g., in a flat position, to accommodate airing when desired, or can be laid flat on a bottom side with a top side opened somewhat retaining its original container shape.

As already noted, the containers are described herein as relating to sporting applications, but it will be understood that such containers are also applicable to a wide variety of applications involving a wide variety of equipment. Thus, equipment, as used herein, refers to any item that can become moist, wet, and/or odiferous after use. By that, equipment can include equipment used outdoors or in wet/moist environments, whether clothing, electrical, mechanical or otherwise, and such will be appreciated by those skilled in the art.

Illustrative embodiments of the invention being thus described, variations, modifications and adaptations to various containers, support structure and the like will occur to those skilled in the art, and these are considered to be within the scope of the invention. Accordingly, the invention is not to be limited by what has been particularly shown and described, but is understood to encompass such variations, modifications and adaptations as will occur to those skilled in the art, as defined by the claims appended hereto and equivalents thereof.

What is claimed is:

1. An apparatus for transporting, storing and airing equipment comprising:
a. a container having an interior defined by one or more sides, each side having an interior surface and an exterior surface, at least side being substantially rigid, and at least one side being movable to provide an opening to a portion of the container interior;
b. one or more attachments that releasably secure equipment, the attachments arranged along an interior surface of at least one side and arranged corresponding to a size and shape and use of the equipment to be releasably secured by the one or more of the attachments; and
c. a support structure, the support structure elevates an end of the container such that the container is disposed at an angle relative to a support floor, whereby the openings provide passage for an air flow to pass over and around the equipment secured in the container interior.

2. The apparatus of claim 1, wherein one or more of the sides are substantially rigid.

3. The apparatus of claim 1, further comprising fasteners, each fastener releasably coupling a side to an adjacent side.

4. The apparatus of claim 3, wherein the fasteners consist of any of the group of zippers, snaps, hook/look arrangements and Velcro.

5. The apparatus of claim 1, wherein the support structure further comprises an elongated structure having a proximal end and a distal end, the proximal end coupled to an exterior surface of a side and the distal end adapted to rest on the support floor, the elongated structure pivots at its proximal end with respect to the side and the distal end rests on the support floor, whereby the container is disposed at an elevated angle relative to the support floor.

6. The apparatus of claim 5, wherein the elongated structure is a bi-pod structure.

7. The apparatus of claim 1, further comprising a fan assembly that provides an air flow into the container interior.

8. The apparatus of claim 7, further comprising a power source coupled to the fan assembly, the power source consisting of any of the group of batteries, solar cells, A/C household current, and D/C current.

9. The apparatus of claim 8, wherein the power source is integrated into the container.

10. The apparatus of claim 1, further comprising one or more wheels and a pull-handle, the wheels disposed at one end of the container along an axis, and the pull-handle disposed on an opposing end of the container whereby pulling on the pull-handle causes container roll along on the wheels.

11. The apparatus of claim 1, wherein a hinge assembly couples to one or more sides of the container, the hinge assembly disposing one or more sides in an open position.

12. The apparatus of claim 11, wherein the hinge assembly has support structures and hinges disposed between the structures, the hinges rotate adjacent structures relative to each other, the hinges have stops such that a structure is rotated at a stationary angle relative to its adjacent structure.

13. The apparatus of claim 1, wherein the container is a sporting bag.

14. The apparatus of claim 1, wherein the attachments are arranged corresponding to ice-hockey equipment.

15. A method for using an apparatus for transporting, storing and airing equipment comprising:
a. obtaining at a first location an apparatus having a container and a support structure, the container having an interior defined by one or more sides, each side having an interior surface and an exterior surface, at least one side being movable to provide an opening into a portion of the container interior, at least one side having one or more attachments along its interior surface, the attachments arranged to correspond to equipment stored in the container interior, the attachments releasably securing the equipment;
b. releasably securing one or more pieces of equipment to the attachments;
c. transporting the container to a second location;
d. moving at least one side to provide an opening to a portion of the container interior;
e. removing one or more pieces of the equipment;
f. using the one or more pieces of equipment;
g. releasably securing the equipment used to the attachments;
h. deploying the support structure, the support structure elevating an end of the container relative to a support floor, whereby the container is disposed at an angle relative to the support floor; and
i. moving one or more sides providing one or more openings into the container, whereby an air flow can pass over and through the equipment secured in the container.

16. The method of claim 15, further comprising:
a. removing a portion of the equipment at the second location;
b. transporting the container to a third location; and
c. removing a further portion of the equipment at the third location.

17. The method of claim 15, further comprising activating a fan to provide the airflow.

18. The method of claim 15, further comprising arranging the fasteners according to a size, shape, weight and use of the equipment.
